(19) United States
(12) Patent Application Publication
(10) Pub. No.: US 2024/0190586 A1
(43) Pub. Date: Jun. 13, 2024

(54) ASSEMBLY SYSTEM AND METHOD FOR ASSEMBLING AIRCRAFT SYSTEM COMPONENTS IN THE TRIANGLE REGION

(71) Applicant: Airbus Operations GmbH, HAMBURG (DE)

(72) Inventor: Eckart FRANKENBERGER, HAMBURG (DE)

(21) Appl. No.: 18/529,324

(22) Filed: Dec. 5, 2023

(30) Foreign Application Priority Data
Dec. 9, 2022 (EP) 22212621.1

(51) Int. Cl. B64F 5/10; B64F 5/50

(52) U.S. Cl. CPC B64F 5/10; B64F 5/50

(57) ABSTRACT

An assembly system for assembling aircraft system components in a triangle region of an aircraft. The assembly system includes a support structure, a guide attached to the support structure, at least one holder attached to the support structure for releasably holding an aircraft system component, and a guide rail inserted in a portion of the triangle region. At least a portion of the support structure is configured to be moved in a direction perpendicular to the longitudinal direction of the support structure.

### CROSS-REFERENCES TO RELATED APPLICATIONS

This application claims the benefit of the European patent application No. 22212621.1 filed on Dec. 9, 2022, the entire disclosures of which are incorporated herein by way of reference.

### FIELD OF THE INVENTION

The invention relates to an assembly system and method for assembling aircraft system components in a triangle region in a lower deck of an aircraft. More particularly, the invention relates to an assembly system and method for assembling aircraft system components having a support structure that can be inserted in the longitudinal direction of the triangle region.

### BACKGROUND OF THE INVENTION

In the lower deck of an aircraft, such as a cargo deck, i.e., in a region of the aircraft fuselage below an intermediate floor, there are usually two so-called triangle regions. In a cross-sectional view of the aircraft, these are each defined by the outer structure of the aircraft fuselage (for example, formers and stringers), the transverse spars of the intermediate floor (for example, the beams of the intermediate floor) and so-called Z-braces, which usually run vertically between a beam of the intermediate floor and a frame, and are usually located on both sides of the aircraft. The Z-braces serve, in particular, to support the intermediate floor in the vertical direction and to stiffen the aircraft structure below the intermediate floor.

The mostly relatively rectangular space between the opposing Z-braces is usually used as a cargo hold or installation space for aircraft technology. The triangle regions, on the other hand, are often used for routing ducts along the outer structure of the aircraft fuselage or longitudinal direction of the aircraft. Normally, no interfering components are located in the triangle regions, especially in the transverse direction of the aircraft, so that ducts from the nose to the tail of the aircraft, or at least from the wings to the nose or tail of the aircraft, can be routed in the triangle regions.

However, during installation in the triangle regions, the working area is difficult to access for the relevant personnel. On the one hand, the Z-braces are in the way when installing ducts in the triangle region. On the other hand, the working height is limited due to the intermediate floor. Both lead to ergonomically unfavorable conditions for the personnel.

Attempts have been made to attach the ducts to the outer structure of the aircraft before the Z-braces are installed. However, this means that in this condition the intermediate floor either cannot yet be installed or cannot be loaded. Therefore, any removal of the upper deck must wait until the Z-braces are installed. On the other hand, because of the load application and also because of the distance from the outer skin, it is desirable to attach ducts to the Z-braces so that the holders are not all attached to the outer structure of the aircraft. Thus, installation of ducts after installation of the Z-braces is preferable.

It is therefore an object of the invention to provide a system and method for improved assembly of aircraft system components.

### SUMMARY OF THE INVENTION

According to a first aspect for better understanding of the present disclosure, an assembly system for assembling aircraft system components in a triangle region in a lower deck of an aircraft comprises: an elongate support structure, a guide means attached to the support structure and designed to guide the support structure, and at least one holder attached to the support structure and designed to releasably hold an elongate aircraft system component.

In the aircraft, at least one triangle region is present in the lower deck. Usually, a triangle region is present on each side of the aircraft along the longitudinal direction of the aircraft. In a cross-sectional view of the aircraft, these are each defined by the outer structure of the aircraft fuselage (for example, the formers and/or stringers), the transverse spars of the intermediate floor (for example, the beams of the intermediate floor) or the intermediate floor itself, and so-called Z-braces supporting a beam of the intermediate floor (or the intermediate floor itself) on a former and usually running vertically, and are usually located on both sides of the aircraft.

The triangle region extends over a certain length in the aircraft, which is why this extension is also referred to here as the longitudinal direction of the triangle region. In certain aircraft configurations, for example, the so-called low-wing configuration, the triangle region is interrupted by a wing center box and/or by a main landing gear bay. Predominantly, the longitudinal direction of the triangle region is parallel to the longitudinal direction of the aircraft (for example, the centerline from the nose to the tail of the aircraft). Since the triangle region is also defined by the width and/or outer structure of the aircraft, and this can also be curved, in these regions the longitudinal direction of the triangle region can deviate from or be oblique to a longitudinal direction (longitudinal axis) of the aircraft. The longitudinal direction of the triangle region is thus to be understood as a direction running along the outer structure of the aircraft and/or along the Z-braces.

An elongate aircraft system component means a component that is larger/longer in one direction than in other directions. In particular, ducts fall under such elongate aircraft system components. For example, ducts for conditioned air, exhaust air, ram air, bleed air, hydraulics, electrics, water, waste water, etc., can be routed in the triangle regions. These ducts typically have a length that (significantly) exceeds the distance between two adjacent formers or Z-braces in the longitudinal direction of the triangle region. In particular, these elongate aircraft system components can have a length that spans a plurality of Z-braces, i.e., are routed along the plurality of Z-braces.

Of course, short (in the longitudinal direction) aircraft system components can also be held by the at least one holder. However, components shorter than the distance between two Z-braces are also easier to install. In any case, however, all aircraft system components can be pre-assembled on the support structure, outside the aircraft fuselage, thus creating ergonomically good conditions.

The assembly system further comprises a guide rail designed to be inserted in a portion of the triangle region and in the longitudinal direction of the triangle region. The portion of the triangle region is defined by the formers and/or the Z-braces and/or a transverse spar or beam of the intermediate floor. It can be, by way of example, a lower region of the triangle region. Thus, the portion can be, for example, a region on the formers or a region where the Z-braces are attached to, integrated into, or otherwise cross/touch the region of the formers. It can, of course, alternatively or additionally be an upper and/or lateral region of the triangular region.

The guide means is designed to be moved along the guide rail. For example, the guide means can be moved in the guide rail, wherein movement takes place, in particular, in the longitudinal direction of the triangle region. The guidance by the guide rail therefore mainly concerns a support transverse to the longitudinal direction of the guide rail and thus transverse to the longitudinal direction of the triangle region.

Further, the support structure is sized such that the support structure can be inserted into the triangle region through the guide means and the guide rail in the longitudinal direction of the triangle region. In other words, the support structure has a cross-section that is smaller than the cross-section of the triangle region so that the support structure can move through the cross-section of the triangle region while being guided by the guide rail and guide means.

Lastly, at least a portion of the support structure is designed to be moved in a direction perpendicular to the longitudinal direction of the support structure. This can be a linear movement, a circular movement, or a movement along any path. In this regard, the portion of the support structure that can be moved transversely allows the at least one holder (or at least one holder if there are a plurality of holders) to be moved, thereby also moving the aircraft system component attached thereto. This allows the aircraft system component to be aligned within the triangle region while maintaining a compact cross-section during insertion into the triangle region with the support structure.

To enable assembly of the aircraft system component in the triangle region, the guide rail and guide means serve to align the aircraft system component in the longitudinal direction of the triangle region, and the movement of the at least one portion of the support structure serves to align the aircraft system component in the transverse direction of the triangle region.

The movement of the at least one portion of the support structure can be such that the aircraft system component is brought into its final position within the cross-section of the triangle region. For example, the movement of the at least one portion can comprise a horizontal and/or vertical movement component such that the aircraft system component can be moved to (almost) any position within the cross-section of the triangle region.

Ultimately, the aircraft system component can be attached in the triangle region. For example, the aircraft system component can be attached to the outer structure of the aircraft fuselage, for example a former and/or stringer, to a transverse spar of the intermediate floor, for example a beam of the intermediate floor or the intermediate floor itself, and/or to a Z-brace.

In one variant, the support structure can comprise at least one longitudinal member and a plurality of vertical members. The at least one longitudinal member extends in the longitudinal direction of the triangle region, while the plurality of vertical members are each arranged perpendicularly thereto and substantially vertically. Here, the at least one longitudinal member takes over the distribution of the loads of the assembly system in the longitudinal direction and onto the guiding device.

In another variant, the at least one holder can be attached to the plurality of vertical members. Thus, the plurality of vertical members primarily serves to allow the at least one holder to be arranged at (any) vertical position within the cross-section of the triangle region such that the aircraft system component held thereby is at or near its final position within the cross-section of the triangle region. Further, a vertical member also allows multiple aircraft system components to be arranged one above the other.

In another variant, the at least one portion of the support structure can be one vertical member of the plurality of vertical members that is movable in the direction perpendicular to the longitudinal direction of the support structure. In other words, a vertical member is moved in a plane parallel to a cross-section of the triangle region. This allows for movement of an aircraft system component within the triangle region. The movement of the vertical member can be any movement, such as a linear movement, circular movement, elliptical movement, or movement along any path.

In yet another variant, the one vertical member can be connected to another vertical member of the plurality of vertical members via a joint and a spreading device and can be rotated relative to the other vertical member. The joint in this case forms a pivot point of the rotary movement of the vertical member. The spreading device can be any device variable in length and arranged such that its length determines a distance between the vertical member and the further vertical member. This distance determines an arc length by which the one vertical member is rotated about the joint relative to the further vertical member.

Alternatively or additionally, the one vertical member can be connected to a longitudinal member via a joint and rotated relative to the longitudinal member. The same conditions apply as above for the rotary movement of one vertical member relative to another vertical member, wherein the longitudinal member forms the fixed element instead of the other vertical member.

Also alternatively or additionally, the further vertical member and/or the longitudinal member can be rotated about the joint. In other words, the movement of the support structure is not limited to the rotational movement of the one vertical member, but multiple elements of the support structure can be rotated (in cross-sectional view of the triangle region). This allows for a compact arrangement of the support structure with the aircraft system components attached to it, and flexible movement and orientation of the aircraft system component(s) within the triangle region.

In another variant, the support structure can comprise at least one cross member variable in length transversely to the longitudinal direction of the support structure. A cross member here means that this is located in a cross-sectional plane of the triangle region, wherein the change in the length of the cross member takes place within this plane. This does not necessarily have to be a linear extension, but can also be a circular, elliptical or any change between the start and end points of the cross member.

In yet another variant, a holder of the at least one holder can be arranged at a free end of the at least one cross member. Thus, by changing the length of the cross member, the holder, and thus an aircraft system component held thereby, can be changed in position as desired within the cross-section of the triangle region. For example, the aircraft system component can be brought to its final position in the triangle region.

In a variant, the assembly system can further comprise a further guide rail designed to be arranged in a different portion of the triangle region than the guide rail (described above), and a further guide means designed to be moved along the further guide rail and to guide the support structure. For example, movement can take place in the longitudinal direction of the triangle region.

The first-described guide rail can be arranged, for example, in a lower or lateral portion of the triangle region. The further guide rail can be arranged, for example, in an upper or lateral portion of the triangle region.

The lower and upper guide rails are optimized for vertical support of the load of the assembly system and uptake of force components transverse (horizontal) to the longitudinal direction of the respective guide rail and thus transverse to the longitudinal direction of the triangle region. A lateral guide rail enables lateral guidance from the outset, i.e., support against transverse forces (horizontal forces), while vertical load components must be introduced into the respective guide rail elsewhere.

In any case, the support structure is held in the transverse direction of the triangle region by the guide rail and the further guide rail, while the support structure can be easily moved in the longitudinal direction of the triangle region. In other words, the support structure is secured against tilting, which facilitates insertion into the triangle region.

Of course, the assembly system can also be stably inserted into the triangle region with only one guide rail and guide means. For example, the assembly system can be designed so that its center of gravity (including the attached elongate aircraft system component(s)) is located above a guide rail in the lower portion of the triangle region. This makes it difficult for the entire assembly system to tilt and facilitates insertion into the triangle region.

Likewise, the assembly system can also be equipped only with the guide rail and guide means in the upper portion of the triangle region, wherein the support structure and thus the assembly system hang from the upper guide rail. This eliminates the problem of the assembly system tilting.

In another variant, the at least one holder can have a receiving surface that corresponds to a portion of an outer surface of an aircraft system component. Thus, the receiving surface can take any shape determined by the portion of the outer surface of the aircraft system component. Thus, the receiving surface and the surface of the aircraft system component can be a part of a cylinder, sphere, cuboid, cube, polygon, or any shape.

Of course, the receiving surface can also be made of or coated with an elastic material. This makes it easier to pick up and hold the aircraft system component, and also protects it.

In yet another variant, the receiving surface can be configured to contact the aircraft system component at a location in the longitudinal direction of the component where the aircraft system component is not (finally) attached in the triangle region. Thus, the receiving surface and, in particular, the holder, does not interfere with the final assembly of the aircraft system component.

In a further variant, the at least one holder can comprise a hook-and-loop strip designed to hold or engage around the aircraft system component. This allows the aircraft system component to be releasably attached to the holder and, thus, to the support structure.

Alternatively or additionally, the at least one holder can comprise a clip designed to releasably hold the aircraft system component. The clip is a holder having a clamping function and/or a latching function, wherein at least a portion of the clip deforms elastically as the aircraft system component is pushed into the clip and subsequently surrounds the aircraft system component, at least in part.

In any case, the holder can be attached to the aircraft system component in a manner that does not interfere with a final assembly position of the aircraft system component. By way of example only, the holder and/or a vertical member to which the holder is attached can be spaced longitudinally of the triangle region from a former or Z-brace. Typically, the holders are provided for final assembly of the aircraft system component to a former or Z-brace (or a transverse beam of the intermediate floor).

In yet a further variant, the assembly system can further comprise a two-part assembly device, wherein a first part of the assembly device is designed to be attached to the aircraft system component and to support the latter, and a second part of the assembly device is designed to be attached to a Z-strut, a transverse spar (beam) of the intermediate floor, or a former (frame) of the aircraft. This allows a portion of the assembly device to be attached to the aircraft system component before it is inserted into the triangle region with the support structure. This facilitates the final assembly of the aircraft system component.

In a variant, the two-part assembly device can comprise a plug-in connection, a detent connection, a rail connection, a screw connection, and/or a clamping connection.

In this regard, the two-part assembly device can be configured to bring the two parts of the assembly device together (to achieve the final assembly position) in a direction that corresponds to a direction of movement that the aircraft system component performs when the portion of the support structure is moved perpendicular to the longitudinal direction of the support structure. In other words, moving the portion of the support structure not only brings the aircraft system component to its final position, but also simultaneously brings together or interlocks corresponding parts of an assembly device.

This significantly simplifies and speeds up the assembly of the aircraft system component by moving the aircraft system component to its final assembly position in a single step. In particular, when multiple aircraft system components are held on the support structure and are all brought into their final assembly position at once by the movement of the portion of the support structure, the assembly of the aircraft system components is significantly simplified and accelerated.

According to a second aspect for better understanding of the present disclosure, a method for assembling an aircraft system component in a triangle region in a lower deck of an aircraft comprises the steps of:
inserting a guide rail into a portion of the triangle region and in the longitudinal direction of the triangle region;
providing a support structure comprising a guide means and at least one holder;
attaching an elongate aircraft system component to the at least one holder;
inserting the support structure into the triangle region in the longitudinal direction of the triangle region by moving the support structure along the guide rail by means of the guide means;
moving at least a portion of the support structure in a direction perpendicular to the longitudinal direction of the support structure such that the elongate aircraft system component is brought into a final assembly position within the triangle region;
attaching the aircraft system component to at least one primary structural component of the aircraft forming the triangle region;
releasing the aircraft system component from the at least one holder; and
moving the support structure out of the triangle region.

The method can be carried out with an assembly system according to the first aspect or one of its variants, or a combination of these variants. Thus, the comments made for the first aspect apply equally for the method according to the second aspect.

In one variant, the method can further comprise attaching a first part of an assembly device to the aircraft system component, and attaching a second part of the assembly device to a Z-brace, transverse spar (beam), or former (frame) of the aircraft. In this regard, attaching the aircraft system component can include connecting the first and second parts of the assembly device.

This connection can also be made simultaneously with the movement of the at least one portion of the support structure, or by the movement of the at least one portion of the support structure.

In a further variant, the method can further comprise removing the guide rail from the triangle region.

The aspects, embodiments, variants and examples described above can of course be combined without being explicitly described. Each of the described variants and examples are thus optional for any of the aspects, embodiments, variants and examples or even combinations thereof. Thus, the present disclosure is not limited to the individual embodiments and variants in the order described or any particular combination of the aspects and variants.

### BRIEF DESCRIPTION OF THE DRAWINGS

Preferred exemplary embodiments of the invention will now be explained in greater detail with reference to the accompanying schematic drawings, wherein:

FIG. 1 schematically shows a portion of a lower deck of an aircraft with two triangle regions;

FIG. 2 schematically shows a side view of an assembly system;

FIG. 3 schematically shows a cross-sectional view of an assembly system in a triangle region;

FIG. 4 schematically shows a cross-sectional view of an aircraft system component with assembly device;

FIG. 5 schematically shows a cross-sectional view of another assembly system in a triangle region;

FIG. 6 schematically shows a cross-sectional view of yet another assembly system; and

FIG. 7 schematically shows a flow diagram of a method for assembling an aircraft system component.

### DETAILED DESCRIPTION OF THE PREFERRED EMBODIMENTS

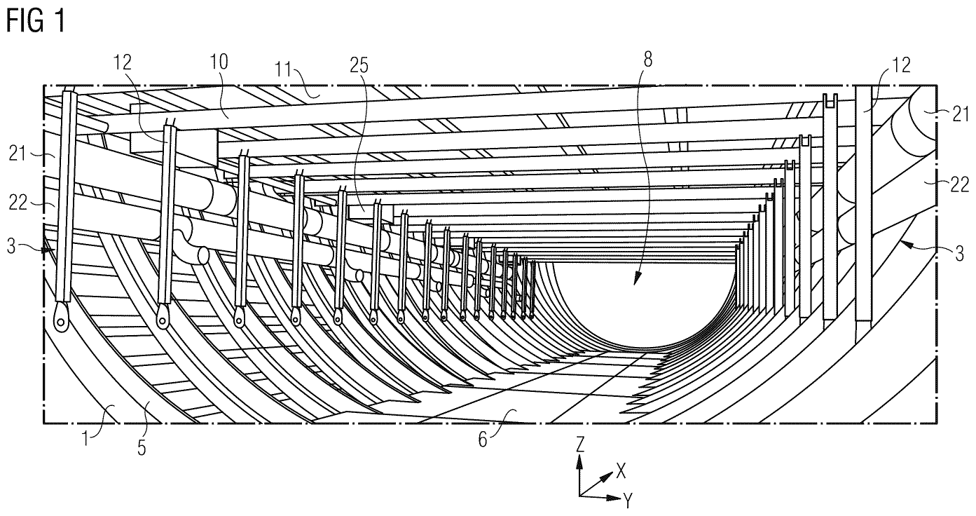

FIG. 1 schematically shows a portion of a lower deck 8 of an aircraft 1 with two triangle regions 3. The lower deck 8 of the aircraft 1 relates to a portion of the aircraft 1 which is arranged at the bottom in the cross-section of the aircraft 1, such as the cargo deck, as shown in FIG. 1 with a cargo floor 6. The cargo deck 8 is bounded at the top by an intermediate floor 11, which is, for example, a cabin floor of a passenger cabin arranged above. While transverse spars or beams 10 of the intermediate floor 11 span the cross-section of the aircraft 1, support of the beams 10 via Z-braces 12 is expedient structurally and also to prevent vibration. These Z-braces 12 are attached to the bottom of the transverse spars or beams 10. For ease of attachment, the transverse spars or beams 10 have the same grid pattern as formers or frames 5 of the aircraft 1, wherein the transverse spars or beams 10 are also attached at their ends to a former or frame 5 of the aircraft 1. The Z-braces 12 are thus arranged at their lower end above a former or frame 5, and therefore they can also be attached to the former or frame 5.

These three components (transverse spar 10, former 5 and Z-strut 12) surround (define) a triangle region 3 in the cross-section of the aircraft 1. This has a substantially triangular shape, wherein a rounding of the aircraft fuselage is usually present on the side of the former 5. Such a triangle region 3 is usually present on both sides of the aircraft 1, or rather at both ends of the transverse spar or beam 10.

At least one of these triangle regions 3 houses aircraft system components 21, 22 (collectively denoted by 20). These elongate aircraft system components 20 extend substantially in the longitudinal direction of the triangle region 3. This longitudinal direction of the triangle region 3 is determined by the alignment of the Z-braces 12 and the formers 5. Usually, this longitudinal direction corresponds to the longitudinal direction X of the aircraft 1. However, the cross-section of the aircraft 1 may also change (for example, taper), whereby the longitudinal direction of the triangle region 3 may be oblique to the longitudinal axis X of the aircraft 1.

Moreover, a vertical direction (in the cross-section of the aircraft 1) corresponds to a Z-axis (vertical axis), while a horizontal direction (in the cross-section of the aircraft 1) corresponds to a Y-axis (horizontal axis). These two axes are perpendicular to the longitudinal axis X of the aircraft 1. The Z-struts 12 can be arranged vertically, i.e., oriented parallel to the Z-axis. Alternatively, the Z struts 12 can be oriented obliquely to the Z axis. Advantageously, however, the Z struts 12 lie in the cross-sectional plane, i.e., in the YZ plane, in which a former 5 is usually also arranged.

As shown in FIG. 1, the aircraft system components 20 are located behind the Z struts 12 when viewed from the center of the aircraft 1. This makes the aircraft system components 20 difficult to reach. In particular, during installation of the aircraft system components 20, the Z struts 12 may present an obstruction.

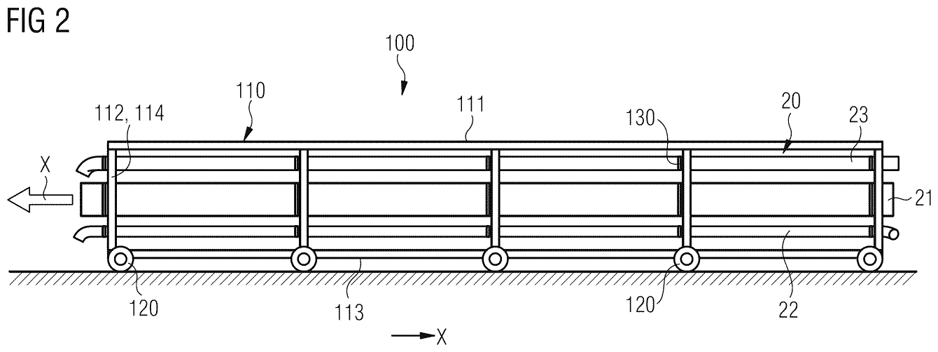

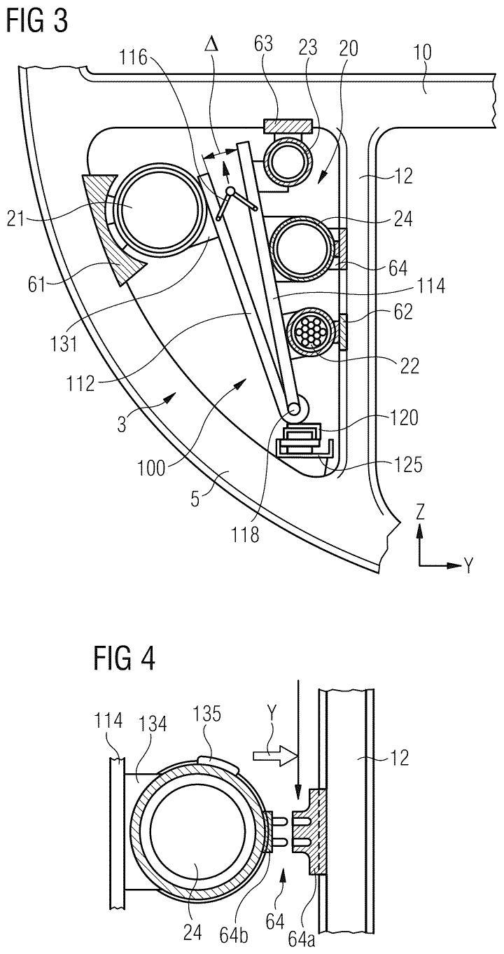

FIG. 2 schematically shows a side view of an assembly system 100 that facilitates the assembly of aircraft system components 20. The assembly system 100 comprises an elongate support structure 110, a guide means 120, and at least one holder 130, which will be described in greater detail with reference to FIGS. 3 to 6.

For example, the elongate support structure 110 can comprise one or more longitudinal members 111, 113 extending over the length of the support structure 110. Vertical members 112, 114 can be arranged therebetween to form a frame with the longitudinal members 111, 113. This frame provides a stable structure to attach aircraft system components 20 thereto.

The guide means 120 is shown in the form of a plurality of castors 120. Of course, other forms of guide means 120 can be used, for example sliders, rollers, balls, or the like.

The assembly system 100 can be moved in the longitudinal direction of the support structure 110 (for example, in the longitudinal direction X) in order to be inserted into a triangle region 3, for example.

FIG. 3 schematically shows a cross-sectional view of an assembly system 100 in a triangle region 3, for example while the assembly system 100 is inserted into the triangle region 3. For this purpose, the assembly system 100 further comprised a guide rail 125, which is inserted, for example, in a lower portion of the triangle region 3.

The guide means 120 can now be moved along the guide rail 125. For example, the guide rail 125 can have a U-profile in which the guide means 120 can slide or roll. The vertically arranged legs of the U-profile serve to provide lateral support for the guide means 120 while the support structure 110 is pushed into the triangle region 3 along the guide rail 125.

The support structure 110 is sized here so as to be able to fit within and be inserted into the cross-section of the triangle region 3. In other words, and as shown in FIG. 3, the occupied cross-section of the support structure 110 is smaller than the cross-sectional area of the triangle region 3. The occupied cross-section here also comprises the aircraft system components 20 that are detachably attached to the support structure 110.

As can be seen from FIG. 3 and also FIG. 4, the assembly system 100, in particular the support structure 110, has at least one holder 130 (holder 134 for component 24 in FIG. 4) on which (in each case) an elongate aircraft system component 20 is releasably held. For this purpose, each holder 130 has an exemplary receiving surface corresponding to a portion of an outer surface of an aircraft system component 20. To hold the aircraft system component 20 in this receiving surface, the holder 130 can further comprise a releasable attachment element 135. The releasable attachment element 135 can be, for example, a hook-and-loop strip 135 that engages around the aircraft system component 20. The hook-and-loop strip 135 can pass through a loop (not shown) and be hooked onto itself to releasably hold the aircraft system component 20 to the holder 130.

Alternatively or additionally, the holder 130 can comprise a clip 136 (see FIG. 6) into which the aircraft system component 20 is releasably inserted. In particular, an elastic deformation of the clip 136 is used here to hold (clamp) the aircraft system component 20. The elasticity of the clip 136 enables easy insertion and removal of the aircraft system component 20 into and from the holder 130.

In FIG. 3, the assembly system 100 is shown as having multiple holders 130 attached to the vertical member 112, 114. This allows multiple aircraft system components 20 to be arranged on top of each other and inserted into the triangle region 3.

Further, FIG. 3 shows an assembly system 100 having two vertical members 112, 114, wherein one vertical member 112 represents a portion of the support structure 110 that is movable in a direction perpendicular to the longitudinal direction of the support structure 110. The longitudinal direction of the support structure 110 is also the longitudinal direction of the triangle region 3 when the support structure 110 is inserted into the triangle region 3. In FIG. 3, the movement of the vertical member 112 is shown by a double arrow, wherein an angle A between the one vertical member 112 and another vertical member 114 is variable.

Merely as an example, the one vertical member 112 can be connected to the further vertical member 114 via a joint 118, and can rotate about the joint 118 relative to the further vertical member 114. The (arcuate) spacing between the two vertical members 112, 114 can be effected via a spreading device 116, or via any element which is variable in its longitudinal extent. The spreading device 116 can be, for example, a threaded rod with a nut which can be rotated by means of a motor, but also an actuator (electrically, pneumatically and/or hydraulically operated) or a linear motor.

Instead of the joint 118, the one vertical member 112 can also be attached to the further vertical member 114 via two spreading devices 116. This allows the two vertical members 112, 114 to be moved relative to each other, wherein tilting movements of one or both vertical members 112, 114 (in the cross-sectional plane shown) are also possible.

Movement of the vertical member 112 or both vertical members 112, 114 can be accomplished in a simple way by appropriate personnel once the support structure 110 is fully inserted longitudinally into the triangle region 3. For example, one or more spreading devices 116 can be provided at one or both ends of the support structure 110. This allows the corresponding spreading device 116 to be operated at one or two positions of the support structure 110. This is much easier to accomplish than threading all of the aircraft system components 20 between the Z-braces 12 and attaching them to appropriate assembly devices.

Both the vertical members 112 and the further vertical members 114 can in each case be connected to each other by longitudinal members 111, 113 to form a frame. Therefore, one or a few spreading devices 116 are sufficient to move the two frames relative to each other.

FIG. 4 schematically shows a cross-sectional view of an aircraft system component 24 with assembly device 64, which is schematically shown for each aircraft system component 20 in FIG. 3, but is only described for one aircraft system component 24. The described applies equally to the other aircraft system components 21, 22, 23.

The aircraft system component 24 is attached to the holder 134 by a hook-and-loop fastener 135. Further, a first part 64a of an assembly device 64 is attached to a Z-brace 12. The assembly device 64 can be a final assembly device for the aircraft system component 24. A second part 64b of the assembly device 64 is attached to and designed to support the aircraft system component 24. Where possible, the second part 64b of the assembly device 64 is secured in a different position longitudinally of the aircraft system component 24 than the hook-and-loop strip 135 to allow the hook and loop strip 135 to be released independently of the assembly device 64.

Referring again to FIG. 3, relative movement between the vertical members 112, 114 not only allows the aircraft system component 21 to move to the left, but also allows the aircraft system components 22, 23, 24 to move to the right. This movement is shown in FIG. 4 by the arrow in the Y-axis direction. In the illustrated variant, the assembly device 64 for the aircraft system component 24 comprises two receptacles in the first part 64a and two associated pins in the second part 64b. Here, the receptacles and pins are oriented such that the pins can be inserted into the receptacles. Here, the direction of movement to insert the pins into the respective receptacles is selected to coincide with the direction of movement of the aircraft system component 24 during movement of the vertical member 114. Thus, only a movement of the vertical carrier 114 allows for assembly of the aircraft system component 24.

Of course, a screw, locking pin, or similar connector can then be added to the assembly device 64 for final assembly of the aircraft system component 24, thereby fixedly connecting the two parts 64a, 64b of the assembly device 64 together. Lastly, the aircraft system component 24 is assembled in its final position.

The remaining aircraft system components 20 are assembled in their final position by corresponding assembly devices 61, 62, 63, wherein these assembly devices 61, 62, 63 can also be formed of two parts. Due to the different arrangement of the aircraft system components 21-24 as well as the assembly devices 61-64, the respective second part of these assembly devices 61-64 attached to the aircraft system component 21-24 can perform a different relative movement in relation to the first part of the respective assembly devices 61-64 attached to an aircraft structure 5, 10, 12 when the portion of the support structure 110 is moved perpendicular to the longitudinal axis of the support structure 110 (for example, the movement of one or both of the vertical members 112, 114). Thus, the assembly devices 61-64 can be configured differently. In particular, the assembly devices 61-64 can be implemented not only in the form of a plug-in connection, but also in the form of a detent connection, a rail connection, a screw connection, and/or a clamping connection. The rail connection can be any plug-in connection with variously shaped rail-like elements instead of pins, wherein the rails extend in the direction in which the respective second part (for example, part 62a) is moved. A clamping connection can comprise a clamping element comprising, for example, a strap, a clamping bracket or a clasp.

The hook-and-loop strip 135 can then be released and the at least one section of the support structure 110, for example the vertical member 114 can be moved back. This allows the support structure 110 to be moved out of the triangle region 3 while the aircraft system components 20 remain in their final position.

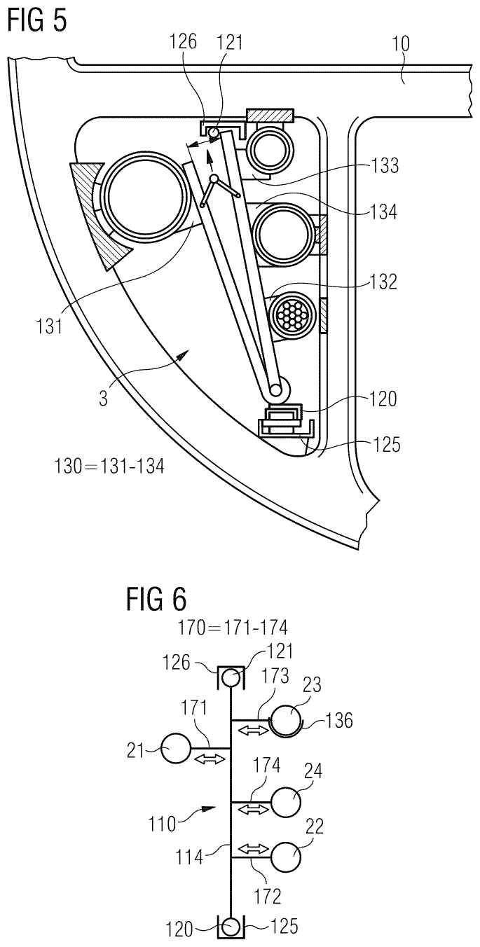

FIG. 5 shows a schematic cross-sectional view of a further assembly system 100 in a triangle region 3. Most of the elements of the assembly system 100 shown correspond to those of the assembly system 100 from FIG. 3. Therefore, these same elements are not described again. However, FIG. 5 shows reference signs that have been omitted from FIG. 3 for illustration purposes. The differences between the two assembly systems 100 shown in FIG. 3 and FIG. 5 are described below.

The assembly system 100 according to FIG. 5 comprises a further guide rail 126 designed to be arranged in an upper portion of the triangle region 3. For example, the (upper) further guide rail 126 can be attached to a transverse spar 10. Further, the assembly system 100 comprises a further guide means 121 designed to move along the further guide rail 126 and to guide the support structure 110. For example, the further guide rail 126 can be a rail that is shown merely exemplarily in FIG. 5 as an inverted U-profile.

For example, the further guide means 121 can be supported by the further guide rail 126 in the transverse direction of the triangle region 3. Thus, the support structure 110 is protected against tilting by the lower and upper guide rails 125, 126.

Alternatively, the support structure 110 can also be suspended only from an upper guide rail 126, which likewise eliminates the possibility of tilting.

Alternatively or additionally to the embodiments of FIG. 3 or 5, the support structure 110 can be guided on/in one or more lateral guide rails (not shown). This is particularly useful if there are elements in the lower and/or upper portion of the triangle region 3, such as the component 25 shown in FIG. 1.

However, this component 25 can also be an aircraft system component that is inserted with the support structure 110 into its final assembly position within the triangle region 3.

Lastly, FIG. 6 schematically shows a cross-sectional view of yet another assembly system 100. The same elements as in the examples according to FIGS. 3 and 5 are again provided with the same reference signs, and their description is omitted here to avoid repetition. This assembly system 100 has at least one cross member 170 which is variable in length transversely to the longitudinal direction of the supporting structure 110. This length variation is represented by a respective double arrow. For example, the support structure 110 can comprise one or more vertical members 114, wherein each of the cross members 170 projects in a direction from the vertical member 114. However, one or all of the cross members 170 can be attached to a longitudinal member 111, 113.

One of the holders 130 can be disposed at each free end of such a cross member 170. Thus, an aircraft system component 20 can be releasably held at each free end of a cross member 170. By appropriately changing the length of the cross member 170 (for example, by threaded rod and nut, (linear) motor, (electric, pneumatic and/or hydraulic) actuator, etc.), the respective aircraft system component 20 can be removed from the vertical member 114. In doing so, the aircraft system component 20 is moved to its final assembly position. The movement of the cross member 170 can be a circular, elliptical, or arbitrary movement along a path, in addition to a linear movement. For this purpose, the cross member can have corresponding linear and/or round elements that can be moved/moved relative to each other.

As already described with reference to FIG. 3, the aircraft system components 20 can also be attached here to the aircraft structure 5, 10, 12 via an assembly device 61-64. The respective assembly device 61-64 can again comprise at least two parts that can be slid into and/or engage with each other in accordance with the movement of the aircraft system component 20 by the movement of the cross member 170.

Lastly, FIG. 6 again schematically shows a holder in the form of a clip 136, which can be attached in the form of an elastic element to a cross member 170 or also to a vertical member 112, 114 or also to a longitudinal member 111, 113 and can be sized in such a way that an aircraft system component 20 can be inserted into the clip 136. Due to elastic properties of the clip 136, the respective aircraft system component 20 can be releasably held on the support structure 110.

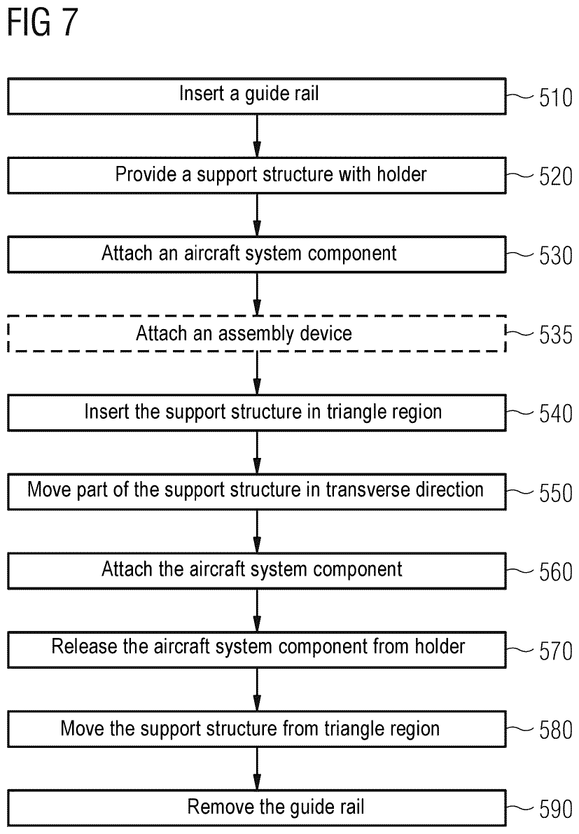

FIG. 7 schematically shows a flowchart of a method for assembling an aircraft system component 20 in a triangle region 3 in a lower deck 8 of an aircraft 1. In this method, a guide rail 125 is first inserted into the triangle region 3 in step 510.

Further, in step 520, a support structure 110 is provided with a guide means 120 and at least one holder 130. An aircraft system component 20 is attached to the at least one holder 130 in a step 530. Optionally, an assembly device 61-64 can also be attached in step 535. For example, a part of the mounting device 64 can be attached to the aircraft system component 20 and another part can be attached to an aircraft structure 5, 10, 12. This work can all be done while the assembly system 100 is outside the aircraft fuselage. This allows for a simple, quick and ergonomically balanced assembly of the aircraft system components 20.

The assembly system 100 prefabricated in this way (in particular, the support structure 110 with attached aircraft system component 20) is inserted into the triangle region 3 in step 540. The support structure 110 is moved along the guide rail 125 by means of the guide means 120.

For example, after reaching the correct position in the longitudinal direction of the triangle region 3, at least a portion of the support structure 110 can be moved in step 550. This movement is transverse to the longitudinal direction of the support structure 110 until the aircraft system component 20 has assumed a final assembly position within the triangle region 3.

There, the aircraft system component 20 can be attached to at least one primary structural component 5, 10, 12 of the aircraft 1 forming the triangle region 3 in step 560, and the aircraft system component 20 can be detached from the holder 130 in step 570.

Lastly, in step 580, the support structure 110 can be moved out of the triangle region 3, and in step 590, the guide rail 125, 126 can be removed from the triangle region 3.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An assembly system for assembling aircraft system components in a triangle region in a lower deck of an aircraft, the assembly system comprising:
an elongate support structure;
a guide attached to the support structure and configured to guide the support structure;
at least one holder attached to the support structure and configured to releasably hold an elongate aircraft system component;
a guide rail configured to be inserted in a portion of the triangle region and in a longitudinal direction of the triangle region,
the guide being configured to be moved along the guide rail,
the support structure being sized such that the support structure can be inserted into the triangle region by the guide and the guide rail in the longitudinal direction of the triangle region, and
at least a portion of the support structure is configured to be moved in a direction perpendicular to the longitudinal direction of the support structure.

2. The assembly system according to claim 1, wherein the support structure comprises at least one longitudinal member and a plurality of vertical members.

3. The assembly system according to claim 2, wherein the at least one holder is attached to the plurality of vertical members.

4. The assembly system according to claim 2, wherein the at least a portion of the support structure is a vertical member of the plurality of vertical members that is movable in the direction perpendicular to the longitudinal direction of the support structure.

5. The assembly system according to claim 4, wherein the vertical member is connected to a further vertical member of the plurality of vertical members via a joint and a spreading device and can be rotated relative to the further vertical member.

6. The assembly system according to claim 1,
wherein the support structure comprises at least one cross member variable in length transversely to the longitudinal direction of the support structure, and
wherein a holder of the at least one holder is disposed at a free end of the at least one cross member.

7. The assembly system according to claim 1, further comprising:
a further guide rail configured to be arranged in another portion of the triangle region; and
a further guide configured to be moved along the further guide rail and to guide the support structure.

8. The assembly system according to claim 1, wherein the at least one holder has a receiving surface corresponding to a portion of an outer surface of an aircraft system component.

9. The assembly system according to claim 1, wherein at least one of:
the at least one holder comprises a hook-and-loop strip configured to hold or engage around the aircraft system component, or
the at least one holder comprises a clip configured to releasably hold the aircraft system component.

10. The assembly system according to claim 1, further comprising:
a two-part assembly device,
wherein a first part of the assembly device is configured to be attached to and to support the aircraft system component, and a second part of the assembly device is configured to be attached to a Z strut, a transverse spar, or a frame of the aircraft.

11. The assembly system according to claim 10, wherein the two-part assembly device comprises at least one of a plug-in connection, a detent connection, a rail connection, a screw connection, or a clamping connection.

12. A method for assembling an aircraft system component in a triangle region in a lower deck of an aircraft, comprising:
inserting a guide rail into a portion of the triangle region and in a longitudinal direction of the triangle region;
providing a support structure comprising a guide and at least one holder;
attaching an elongate aircraft system component to the at least one holder;
inserting the support structure into the triangle region in the longitudinal direction of the triangle region by moving the support structure along the guide rail via the guide;
moving at least a portion of the support structure in a direction perpendicular to the longitudinal direction of the support structure in such a way that the elongate aircraft system component is brought into a final assembly position within the triangle region;
attaching the aircraft system component to at least one primary structural component of the aircraft forming the triangle region;
releasing the aircraft system component from the at least one holder; and
moving the support structure out of the triangle region.

13. The method according to claim 12, further comprising:
attaching a first part of an assembly device to the aircraft system component; and
attaching a second part of the assembly device to a Z-brace, a transverse spar, or a frame of the aircraft,
wherein attaching the aircraft system component comprises connecting the first and second parts of the assembly device.

14. The method according to claim 12, further comprising:
removing the guide rail from the triangle region.
